(19) United States
(12) Patent Application Publication
(10) Pub. No.: US 2017/0137195 A1
(43) Pub. Date: May 18, 2017

(54) PACKAGING FOR FACILITATING SPILL PROOF TRANSFER OF POWDERED NUTRIENT INTO A SMALL OPENING OF A BOTTLE

(71) Applicant: Nicholas J. Singer, Irvine, CA (US)

(72) Inventor: Nicholas J. Singer, Irvine, CA (US)

(21) Appl. No.: 14/941,333

(22) Filed: Nov. 13, 2015

(51) Int. Cl. B65D 75/58; A23L 2/395; A23L 2/66; B65D 1/02; A23J 1/20

(52) U.S. Cl. CPC B65D 75/5811; B65D 1/023; A23J 1/205; A23L 2/66; A23L 2/395; A23V 2002/00

(57) ABSTRACT

A package for transferring a powdered nutrient from the package into a water bottle without spilling the powdered nutrient during the process of transferring is disclosed. The package has an end portion which is sufficiently small to be inserted into the neck of the water bottle and the main portion which is sufficiently large so that the main portion cannot be inserted into the neck of the water bottle. To transfer the powdered nutrient from the package into the water bottle, the end portion is torn to create an opening through which the powdered nutrient is emptied from the package. The end portion is inserted into the neck of the bottle and an edge or step between the end portion and the main portion rests on an edge of the neck as a powdered nutrient is poured into the water bottle. Any remaining powdered nutrient in the package is transferred into the water bottle by lightly shaking the package.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The various aspects described herein relate to packaging with a powdered substance that facilitates spill proof transfer of the powdered substance into a bottle.

Powdered edible substances for mixing with water are typically sold in large containers. By way of example and not limitation, powdered protein and fiber supplements are typically sold in bulk in at least a one liter container. To consume the powdered substance, the user scoops the powdered substance and transfers the powdered substance to a cup. However, in the process of transferring the powdered substance from the container to the cup, oftentimes, the powdered substances is spilled thereby requiring the user to clean up after mixing and consuming the powdered substance.

Accordingly, there is a need in the art for an improved method and apparatus for transferring powdered edible substances into water.

### BRIEF SUMMARY

A package is disclosed wherein the package defines a main portion and an end portion. The main portion is sufficiently large so that the main portion cannot be inserted into a neck or opening of a water bottle. The end portion is sufficiently small so that the end portion can be inserted into the neck of the water bottle. The end portion also has the ability to be torn so that the contents within the package can be poured out of the opening formed in the end portion. To pour the powdered substance into a water bottle, the user tears the end portion, inserts the end portion into the neck of the water bottle. A step between the end portion and the main portion rests on the upper edge of the bottle opening. At this time, the powdered substance in the package flows into the water bottle. If any powdered substance remains in the package, the user can lightly shake the package in order to facilitate or encourage the remaining powdered substance to flow out of the opening of the end portion and into the water bottle. By inserting the end portion into the neck of the water bottle, the powdered substance does not spill and create a mess and does not need to be cleaned up by the user.

More particularly, a package of pouring powdered substance into a water bottle without spilling the powdered substance is disclosed. The package may comprise a powdered protein nutrient and an elongate tube. The elongate tube may define a main portion and an end portion. The main portion may define a first cavity with less than 50 grams of the powdered protein nutrient disposed in the first cavity. The main portion of the elongate tube may have a length greater than a width when the main portion of the tube is filled with the powdered protein nutrient. The width of the main portion may be greater than ⅞ inch when filled with the powdered protein nutrient. The end portion of the elongate tube may have a width less than the main portion. The end portion may have a second cavity. The end portion of the elongate tube may have an outer circumference equal to or less than an inner circumference of a neck of a water bottle wherein the neck of the water bottle has an inner diameter of 13/16 inch so that the end portion may be inserted into the neck of the water bottle while an edge between the end portion and the main portion rests on an edge of the neck to ensure that the package does not inadvertently slip into the water bottle and the powdered protein nutrient is guided into the water bottle without spilling the powdered protein nutrient.

The first cavity may more preferably be sized to fit about 30 grams of the powdered protein nutrient.

The end portion may have a funnel shape. The funnel shaped end portion may be offset to a side of the width of the elongate tube. Alternatively, the funnel shaped end portion may be disposed medially with respect to the width of the elongate tube.

The powdered protein nutrient may be powdered whey protein isolate.

The package may further comprise a water impermeable inner lining disposed on an interior side of the elongate tube so that the first and second cavities are liquid tight.

An outer circumference of an opening at the end portion may be equal to or less than an inner circumference of the neck of the water bottle.

A slit may be located at a heat sealed edge portion of the end portion to facilitate tearing of the end portion and the outer circumference of the opening at the end portion is smaller than an inner circumference of the neck of the water bottle.

In another aspect, a method of pouring a powdered protein nutrient into a water bottle without spilling the powdered protein nutrient is disclosed. The method may comprise the steps of providing a package having an elongate tube defining an end portion, the elongate tube sufficiently large to hold less than about 50 grams of powdered protein nutrient; removing a cap from a water bottle having a neck wherein an inner diameter of the neck is equal to or less than 13/16 inch; removing a sufficient amount of water from the water bottle to provide space within the water bottle so that the amount of powdered protein nutrient disposed in the package is entirely disposable within the water bottle when the cap is engaged to the neck of the water bottle; rupturing the end portion of the elongate tube of the package containing the powdered protein nutrient; inserting an edge of the ruptured end portion into the neck of the water bottle; and shaking the elongate tube so that the powdered protein nutrient flows down into the water bottle through the neck of the water bottle without spilling the powdered protein nutrient.

The providing step may comprise the step of providing the package sufficient to hold 30 grams of powdered protein nutrient.

The rupturing step may comprise the step of tearing the end portion at a slit.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a package containing a powdered nutrient and a water bottle;

FIG. 2 illustrates a lid of the water bottle shown in FIG. 1 removed from the water bottle and the package;

FIG. 3 illustrates a top view of a neck of the water bottle;

FIG. 4 illustrates a partial side view of the package shown in FIG. 1;

FIG. 5 illustrates a cross-sectional view of an end portion of the package at a slit for facilitating tearing of the end portion;

FIG. 6 illustrates an alternate embodiment of the end portion compared to that shown in FIG. 4;

FIG. 7 illustrates a cross-sectional view of an end portion of the package shown in FIG. 6 at a slit for facilitating tearing of the end portion; and

FIG. 8 illustrates the end portion of the package shown in FIG. 1 inserted into the neck of the water bottle to transfer the powdered nutrient in the package to the water bottle without spilling the powdered nutrient.

### DETAILED DESCRIPTION

Referring now to the drawings, a package 10 for pouring a powdered substance 12 into a water bottle 14 having a narrow neck 16 without spilling the powdered substance 12 is shown. The package 10 has an end portion 18a, b which can be torn so that the powdered substance 12 disposed within the package 10 may be poured out of the end portion 18a, b directly into the water bottle 14. The size of the end portion 18a, b is sufficiently small so that the end portion 18 may be inserted into the narrow neck 16 of the water bottle 14 and all of the powdered substance 12 poured into the water bottle 14 without spilling the powdered substance 12. The package 10 may contain about 30 grams of the powdered substance (e.g., powdered whey protein isolate) to provide an optimal amount of nutrients to an adult human being.

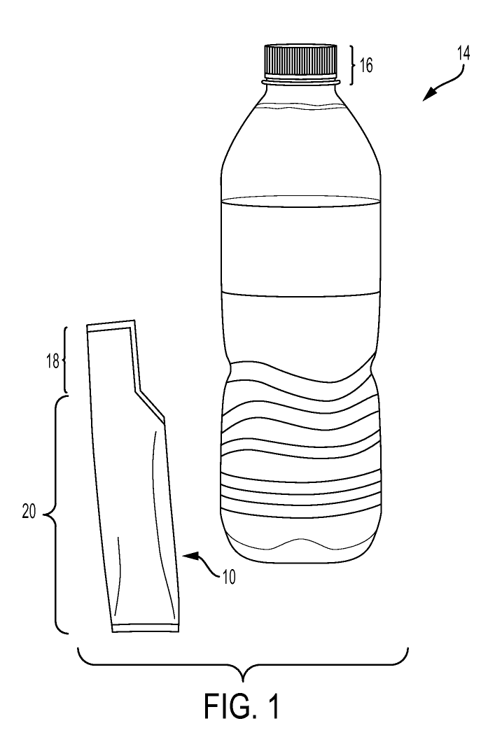

The package 10 may have an elongate tube configuration having a main portion 20 and the end portion 18a, b, as shown in FIG. 1. The elongate tube may be a fin sealed package 10. The main portion 20 of the elongate tube of the package 10 may also be sized to hold about 20 grams to about 50 grams of the powdered substance 12. By way of example and not limitation, the powdered substance 12 may be a whey, protein, whey protein isolate, fiber, nutritional supplement, dietary supplement or combinations thereof. The main portion 20 of the elongate tube of the package 10 may define a first cavity which holds the powdered substance and is sized and configured to hold between about 20 grams to about 50 grams of the powdered substance 12. Preferably, the first cavity is sized and configured to hold 30 grams of the powdered substance 12.

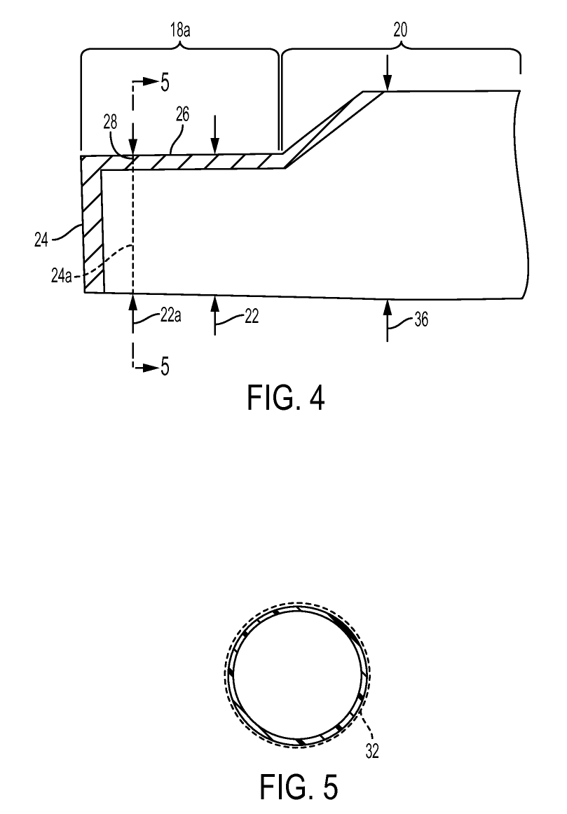

Referring now to FIG. 4, the end portion 18a of the elongate tube of the package 10 may have a funnel shape. The funnel shaped end portion 18a may have a reducing width 22 in which the width 22 is larger near the main portion 20 of the elongate tube compared to an end 24 of the funnel shaped end portion 18a. Other configurations are also contemplated. By way of example and not limitation, the width 22 may be constant throughout the entire length from a part of the end portion 18a that joins with the main portion 20 to the end 24 of the end portion 18a. It is also contemplated that the end 24 may be greater than a part of the end portion 18a closer to the main portion 20 of the elongate tube of the package 10.

The end portion 18a may be formed by simultaneously die cutting and heat sealing an edge portion 26 that defines the shape of the end portion 18a. The funnel shape may be die cut into the end portion 18a during the filling and packaging process. Moreover, a slit 28 may be formed in the edge portion 26 so that a user can rip the funnel shaped end portion 18a at the slit 28 to form an opening at the end portion 18a. A width 22a of the funnel shaped end portion 18a at the slit 28 may in all configurations of the funnel shaped end portion 18a be sufficiently small to allow the end 24a of the funnel shaped end portion 18a at the slit 28a to be inserted into the narrow neck 16 of the water bottle 14.

The width 22a of the end 24a may be less than an inner diameter 30 (See FIG. 3) of the narrow neck 16 of the water bottle 14. After the funnel shaped end portion 18a is ripped at the slit 28, the user may slip the end 24a into the narrow neck 16 of the water bottle wall 14 and begin to shake the package 10 so that the powdered substance 12 in the first cavity begins to exit out of the funnel shaped end portion 18 into the water bottle 14 without any spillage of the powdered substance 12 outside of the water bottle. Alternatively, the end 24a of the funnel shaped end portion 18a at the slit 28 may define an outer circumference 32. (see FIG. 5). The outer circumference 32 may be less than an inner circumference 34 of the narrow neck 16 of the water bottle 14. The fin 36 at the end portion 18a may be tucked in on the side of the funnel shaped end portion 18a so that the funnel shaped end portion 18 can be easily inserted into the narrow neck of the water bottle 14.

The width 36 of the main portion 20 may be greater than the inner diameter 30 of the narrow neck 16 of the water bottle 14. The width 36 of the main portion 20 may be measured when the package 10 is empty and the main portion 20 is flat. Alternatively, the width 36 of the main portion 20 may be measured when the package 10 is filled with the powdered substance. In this case, the main portion 20 will be generally cylindrically shaped and the width 36 of the main portion 20 may be that of the main portion 21 filled with the powdered substance. Preferably, the width 36 of the main portion is greater than the inner diameter 30 of the narrow neck 16 of the water bottle 14 when the width 36 of the main portion 20 is measured when the powdered substance is filled in the main portion 20 so that the main portion 20 is not inserted into the water bottle when pouring the powdered substance into the water bottle. The purpose is to prevent full insertion of the elongate tube into the water bottle. The step 38 between the end portion 18a and the main portion 20 contacts the upper edge 40 of the narrow neck 16 of the water bottle 14 so that only the end portion 18a of the elongate tube of the package 10 can be inserted into the narrow neck 16 of the water bottle 14.

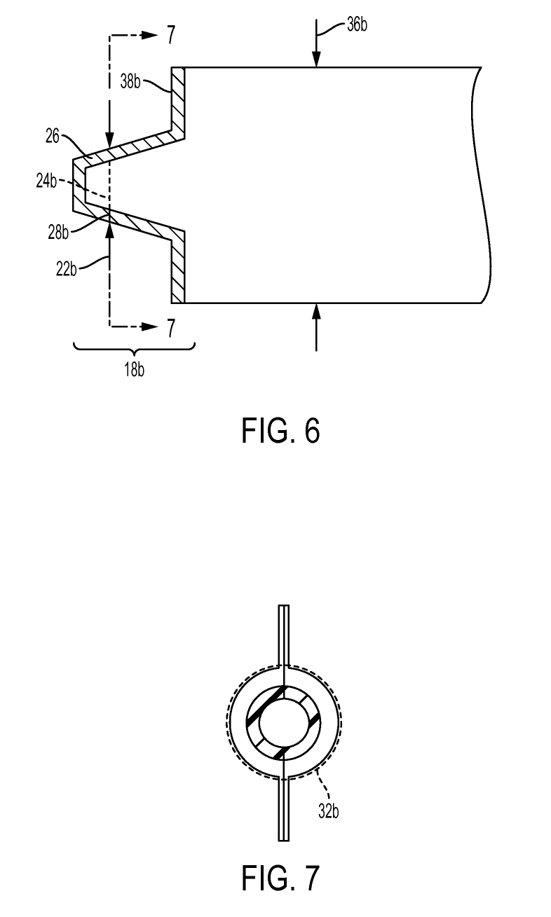

Referring now to FIGS. 4 and 6, two different shapes for the end portion 18a, b are shown. In FIG. 4, the end portion 18a is skewed to one side of the width 36 of the main body 20. In contrast, in FIG. 6, the end portion 18b is disposed in the middle of the width 36 of the main body 20. Nevertheless, both shapes 18a, b function in the same manner. In particular, as discussed above in relation to the end portion 18a, the end portion 18b may be formed by simultaneously die cutting and heat sealing an edge portion 26 that defines the shape of the end portion 18b. The funnel shape may be die cut into the end portion 18b during the filling and packaging process. Moreover, a slit 28b may be formed in the edge portion and partially penetrate the edge portion 26 so that a user can grip the end portion 18b at the slit 28b to form an opening at the end portion 18b. A width 22b of the funnel shaped end portion 18bat the slip 28 be may be inserted into the narrow neck 16 of the water bottle 14.

The width 22b of the end 24bmay be less than an inner diameter 30 of the narrow neck 16 of the water bottle 14. After the funnel shaped end portion 18b is ripped at the slit 28b, the user may slip the end 24b into the narrow neck of the water bottle 14 and begin to shake the package 10 so that the powdered substance in the first cavity begins to exit out of the funnel shaped end portion 18b into the water bottle 14 without any spillage of the powdered substance 12. Alternatively, the end 24b of the funnel shaped end portion 18b at the slit 28b may define an outer circumference 32b (see FIG. 7) may be less than the inner circumference 34 of the narrow neck 16 of the water bottle 14. The fim 36b at the end portion 18b may be tucked in on the side of the funnel shaped end portion 18b so that the funnel shaped end portion 18b can be easily inserted into the narrow neck 16 of the water bottle 14.

The width 36b of the main portion 20 may be greater than the inner diameter 30 of the narrow neck 16 of the water bottle 14. The purpose is to prevent full insertion of the elongate tube into the water bottle 14 when the powdered substance 12 is being poured into the water bottle 14. The step 38b between the end portion 18b and the main portion 20 may contact upper edge 40 of the narrow neck 16 of the water bottle 14 so that only the end portion 18b of the elongate tube of the package 10 can be inserted into the narrow neck 16 of the water bottle 14. This permits for spill proof transfer of the powdered substance 12 from the package 10 into the water bottle 14.

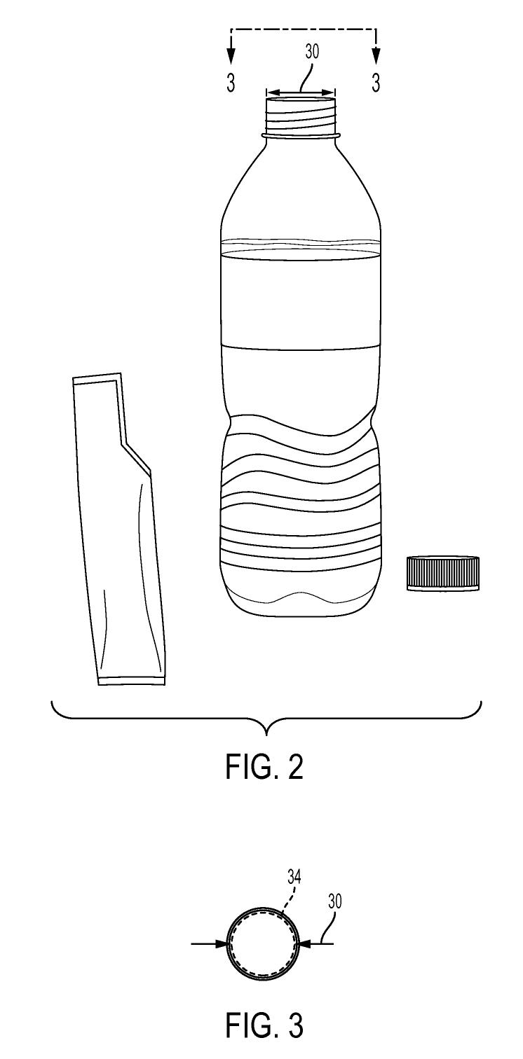

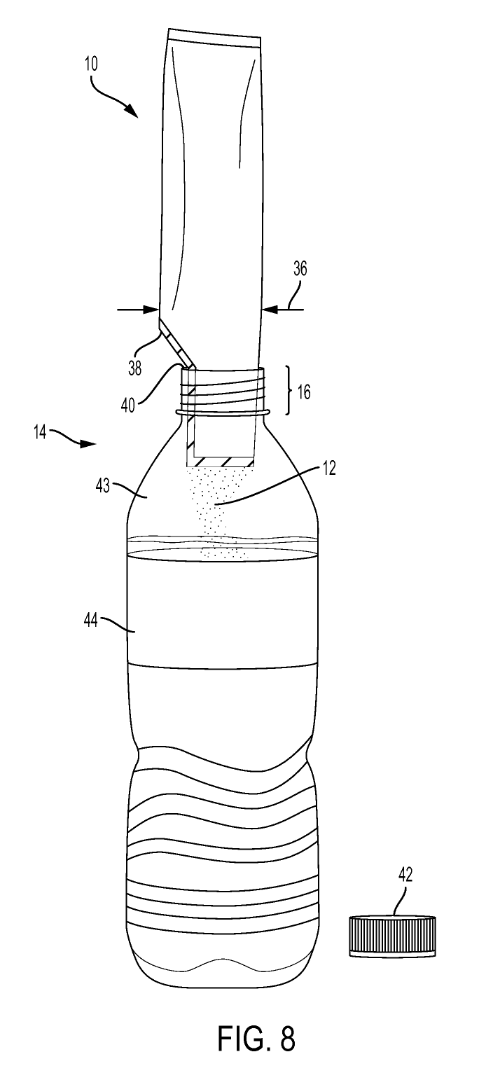

To pour the powered substance 12 into the water bottle 14, the user tears the end portion 18a, b at the slit 28. The water bottle cap 42 is removed and some water is removed to allow room for the powdered substance 12, as shown in FIG. 2. The end portion 18a, b is inserted into the narrow neck 16 of the water bottle 14. The package is now upside down, as shown in FIG. 8. The user can shake the package 10 to urge the powdered substance 12 out of the funnel shaped end portion 18a, b and directly into the water bottle 14. The water in the water bottle 14 may be poured out or drunk to make room or space 43 inside the water bottle 14 so that the powdered substance 12 can be inserted or poured into the water bottle 14, a cap or a lid 42 reengage to the threads of the narrow neck 16, and the water bottle shaken to mix the powdered substance 12 with the water 44. When the powdered substance 12 is poured into the water bottle 14, the powdered substance 12 may initially float on top of the water 44 in the water bottle 14. As such, after pouring the powdered substance into the water bottle 14, the water bottle 14 is closed then shaken.

The above description is given by way of example, and not limitation. Given the above disclosure, one skilled in the art could devise variations that are within the scope and spirit of the invention disclosed herein, including various ways of forming the package. Further, the various features of the embodiments disclosed herein can be used alone, or in varying combinations with each other and are not intended to be limited to the specific combination described herein. Thus, the scope of the claims is not to be limited by the illustrated embodiments.

1-9. (canceled)

10. A method of pouring a powdered protein nutrient into a water bottle without spilling the powdered protein nutrient, the method comprising the steps of:
providing a package having an elongate tube defining an end portion, the elongate tube sufficiently large to hold less than about 50 grams of powdered protein nutrient;
removing a cap from a water bottle having a neck wherein an inner diameter of the neck is equal to or less than 13/16 inch;
removing a sufficient amount of water from the water bottle to provide space within the water bottle so that the amount of powdered protein nutrient disposed in the package is entirely disposable within the water bottle when the cap is engaged to the neck of the water bottle;
rupturing the end portion of the elongate tube of the package containing the powdered protein nutrient;
inserting an edge of the ruptured end portion into the neck of the water bottle; and
shaking the elongate tube so that the powdered protein nutrient flows down into the water bottle through the neck of the water bottle without spilling the powdered protein nutrient.

11. The method of claim 10 wherein the providing step comprises the step of providing the package sufficient to hold 30 grams of powdered protein nutrient.

12. The method of claim 10 wherein the rupturing step comprises the step of tearing the end portion at a slit.

13. The method of claim 10 wherein the providing step further comprises the step of providing the elongate tube defining a main portion and the end portion, a width of the end portion being greater than 7/8 inch , the end portion having a width less than the main portion, the end portion of the elongate tube having an outer circumference equal to or less than yours conference of the neck of a water bottle wherein the neck of the water bottle has an inner diameter of 13/16 inch so that the end portion may be inserted into the neck of the water bottle while an edge between the edge portion of the main portion rests on an edge of the neck to ensure that the package does not inadvertently slip into the water bottle and the powdered protein nutrient is guided into the water bottle without spilling the powdered protein nutrient.

14. The method of claim 13 wherein the providing step further comprises the step of providing the end portion having a funnel shape so that the powdered protein nutrient is urged into the water bottle.

15. The method of claim 14 wherein the providing step further comprises the step of providing the elongate tube with the funnel shaped end portion offset to a side of the width of the elongate tube.

16. The method of claim 14 wherein the providing step further comprises the step of providing the elongate tube with the funnel shaped end portion central to the width of the elongate tube.

17. The method of claim 15 wherein the providing step further comprises the step of providing the elongate tube with a water impermeable inner lining disposed on an interior side of the elongate tube to form a liquid tight cavity and hold the powdered protein nutrient.

18. The method of claim 15 wherein the providing step further comprises the step of providing the elongate tube with an outer circumference of an opening at the end portion is equal to or less than an inner circumference of the neck of the water bottle.
